(19) United States
(12) Patent Application Publication
(10) Pub. No.: US 2008/0019036 A1
(43) Pub. Date: Jan. 24, 2008

(54) POSITIONING DEVICE ADAPTED FOR POSITIONING A DETACHABLE MODULE IN A HOUSING

(76) Inventors: Yu-Chen CHU, Ta-Li City (TW); Kuo-Kuang LIU, Tsao-Tun Chen (TW)

Correspondence Address: OSTROLENK FABER GERB & SOFFEN, 1180 AVENUE OF THE AMERICAS, NEW YORK, NY, 100368403, US

(21) Appl. No.: 11/681,311

(22) Filed: Mar. 2, 2007

(30) Foreign Application Priority Data
Jul. 24, 2006 (TW) 095212994

(51) Int. Cl. G11B 17/025

(52) U.S. Cl. 360/97.01

(57) ABSTRACT

A positioning device includes two guiding members fixed spacedly in a housing. Each guiding member has a hook-shaped guiding slot having an elongate first slot portion, and a curved second slot portion defined by front and rear stop walls. A pivot member is connected pivotally to a detachable module. Two positioning rods of the pivot member are respectively guided by the first slot portions of the guiding slots in the guiding members to move rearwardly as a result of rearward movement of the detachable module until the positioning rods abut respectively against the rear stop walls. The pivot member is then pivoted to move the positioning rods to abut respectively against the front stop walls, thereby resulting in further rearward movement of the detachable module by a predetermined distance in response to continuous pivoting of the pivot member.

### CROSS-REFERENCE TO RELATED APPLICATION

This application claims priority of Taiwanese Application No. 095212994, filed on Jul. 24, 2006.

### BACKGROUND OF THE INVENTION

1. Field of the Invention

The invention relates to a positioning device, more particularly to a positioning device adapted for positioning a detachable module in a housing.

2. Description of the Related Art

In a computer, computer elements, such as an optical disk drive, a hard disk drive, a floppy drive, etc., are usually mounted in a computer housing by means of screw fasteners such that a screw driver is needed during assembly and disassembly. Furthermore, the screw fasteners have a relatively small size so that the screw fasteners detached from the computer housing are easily misplaced, thereby resulting in inconvenience during assembly and disassembly of the computer elements.

### SUMMARY OF THE INVENTION

Therefore, the object of the present invention is to provide a positioning device that enables a detachable module to be easily positioned in and detached from a housing.

According to the present invention, there is provided a positioning device adapted for positioning a detachable module in a housing. The housing has a front open side. The positioning device comprises:

a pair of guiding members adapted to be mounted fixedly in the housing and spaced apart from each other in a first direction, each of the guiding members being formed with a hook-shaped guiding slot, the guiding slot in each of the guiding members having an elongate first slot portion that extends rearwardly from a front end of a corresponding one of the guiding members, and a curved second slot portion connected to the first slot portion and extending downwardly and frontwardly from a rear end of the first slot portion, each of the guiding members having front and rear stop walls spaced apart from each other in a second direction that is perpendicular to the first direction and defining the second slot portion of the guiding slot in the corresponding one of the guiding members therebetween; and

a pivot member adapted to be mounted pivotally on the detachable module such that the pivot member is pivotable relative to the detachable module about an axis parallel to the first direction, the pivot member having opposite pivot blocks adapted to be connected respectively and pivotally to opposite lateral sides of the detachable module, each of the pivot blocks being disposed between a corresponding one of the guiding members and the detachable module when the detachable module is inserted into the housing via the front open side, each of the pivot blocks having an integral positioning rod that extends outwardly in the first direction.

During assembly of the detachable module to the housing, initially, the positioning rods of the pivot blocks of the pivot member are guided respectively by the first slot portions of the guiding slots in the guiding members to move rearwardly as a result of rearward movement of the detachable module until the positioning rods of the pivot blocks of the pivot member abut respectively against the rear stop walls of the guiding members, and subsequently, the pivot member is operable so as to pivot the pivot blocks of the pivot member such that the positioning rods of the pivot blocks of the pivot member move downwardly and frontwardly to abut respectively against the front stop walls of the guiding members, thereby resulting in further rearward movement of the detachable module in response to continuous pivoting of the pivot member by a predetermined distance.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view illustrating the preferred embodiment of a positioning device adapted for positioning a detachable module in a housing according to the present invention;

FIG. 2 is a fragmentary perspective view showing the preferred embodiment when the detachable module is inserted into the housing;

FIGS. 3 to 7 are fragmentary schematic side views showing the preferred embodiment during assembly of the detachable module to the housing; and

FIGS. 8 and 9 are fragmentary schematic side views showing the preferred embodiment during disassembly of the detachable module from the housing.

### DETAILED DESCRIPTION OF THE PREFERRED EMBODIMENT

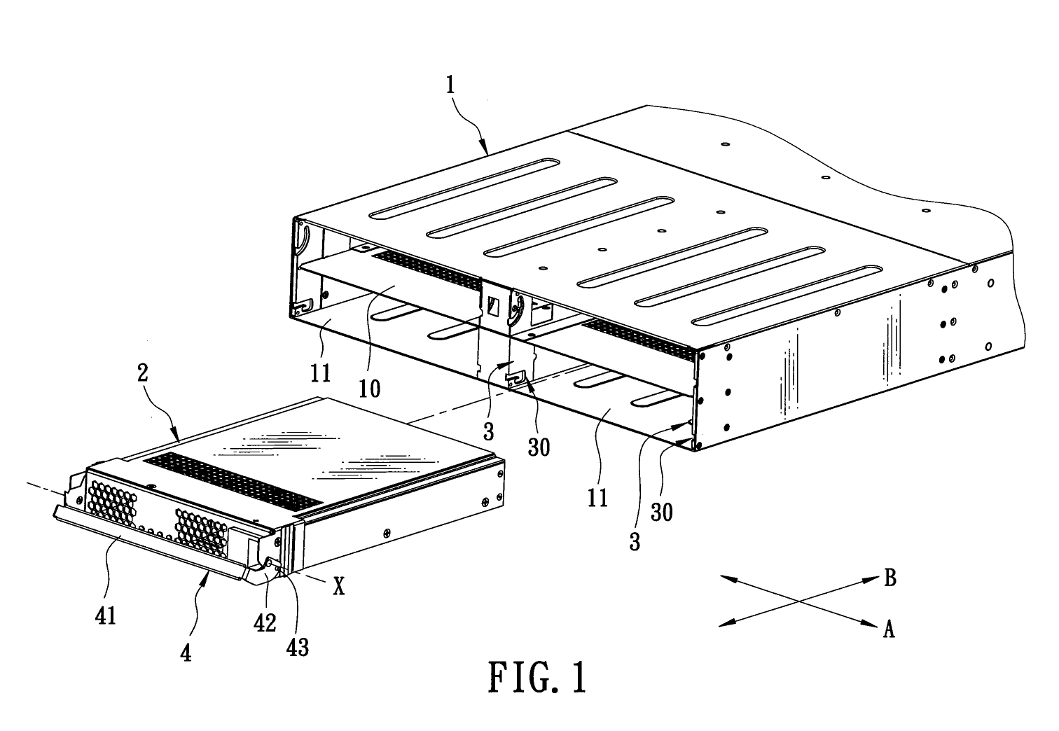

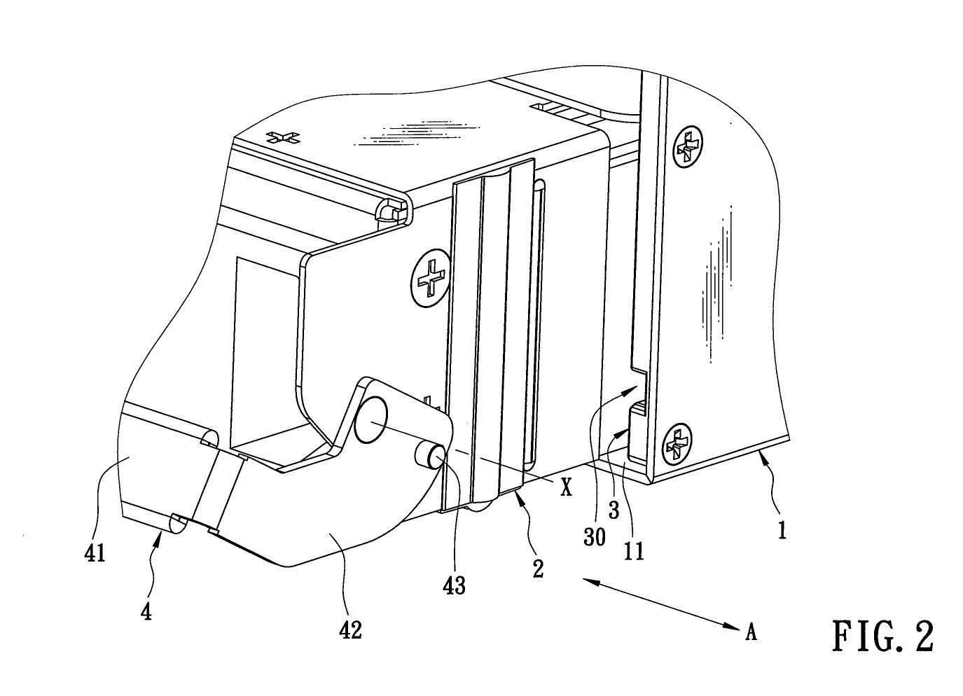

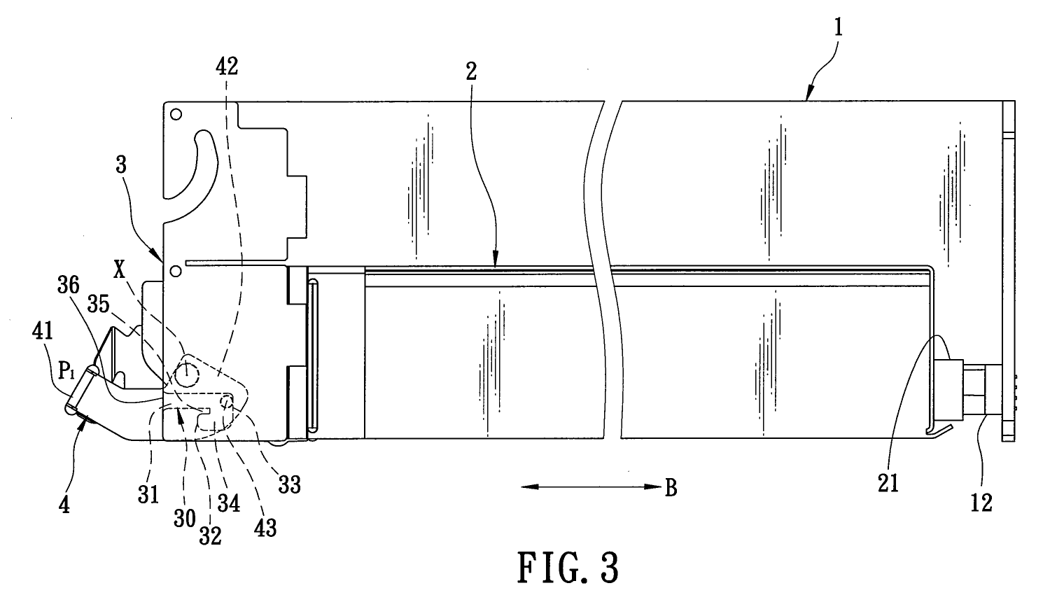

Referring to FIGS. 1 to 3, the preferred embodiment of a positioning device according to the present invention is shown to be adapted for positioning a detachable module 2 in a housing 1. In this embodiment, the housing 1 has a front open side 10, and is configured with four insertion grooves 11. The housing 1 further has four connecting ports 12 (only one is shown in FIG. 3) disposed adjacent to a rear side thereof and corresponding respectively to the insertion grooves 11. The detachable module 2 has a connector 21. When the detachable module 2 is positioned in a selected one of the insertion grooves 11 in the housing 1, the connector 21 of the detachable module 2 is connected electrically to a corresponding one of the connecting ports 12. The positioning device includes a pair of guiding members 3 and a pivot member 4.

The guiding members 3 are adapted to be mounted fixedly in the housing 1, and are spaced apart from each other in a first direction (A). In this embodiment, each guiding member 3 is in the form of a plate body that can serve as a groove-defining wall for defining the selected one of the insertion grooves 11. Each guiding member 3 is formed with a hook-shaped guiding slot 30. For each guiding member 3, the guiding slot 30 has an elongate first slot portion 31 that extends rearwardly from a front end 36 of the plate body, and a curved second slot portion 34 connected to the first slot portion 31 and extending downwardly and frontwardly from a rear end of the first slot portion 31. Each guiding member 3 has front and rear stop walls 32, 33 spaced apart from each other in a second direction (B) that is perpendicular to the first direction (A), and defining the second slot portion 34 of the guiding slot 30 in the corresponding one of the guiding members 3 therebetween, as shown in FIG. 3. Each guiding member 3 further has a protrusion 35 that extends rearwardly from an upper end of the front stop wall 32.

The pivot member 4 is adapted to be mounted pivotally on the detachable module 2 such that the pivot member 4 is pivotable relative to the detachable module 2 about an axis (X) parallel to the first direction (A). In this embodiment, the pivot member 4 has opposite pivot blocks 42 adapted to be connected respectively and pivotally to opposite lateral sides of the detachable module 2, and an intermediate handgrip 41 interconnecting fixedly the pivot blocks 42. Each pivot block 42 is disposed between a corresponding one of the guiding members 3 and the detachable module 2 when the detachable module 2 is inserted into the selected one of the insertion grooves 11 in the housing 1 via the front open side 10. Each pivot block 42 has an integral positioning rod 43 that extends outwardly in the first direction (A).

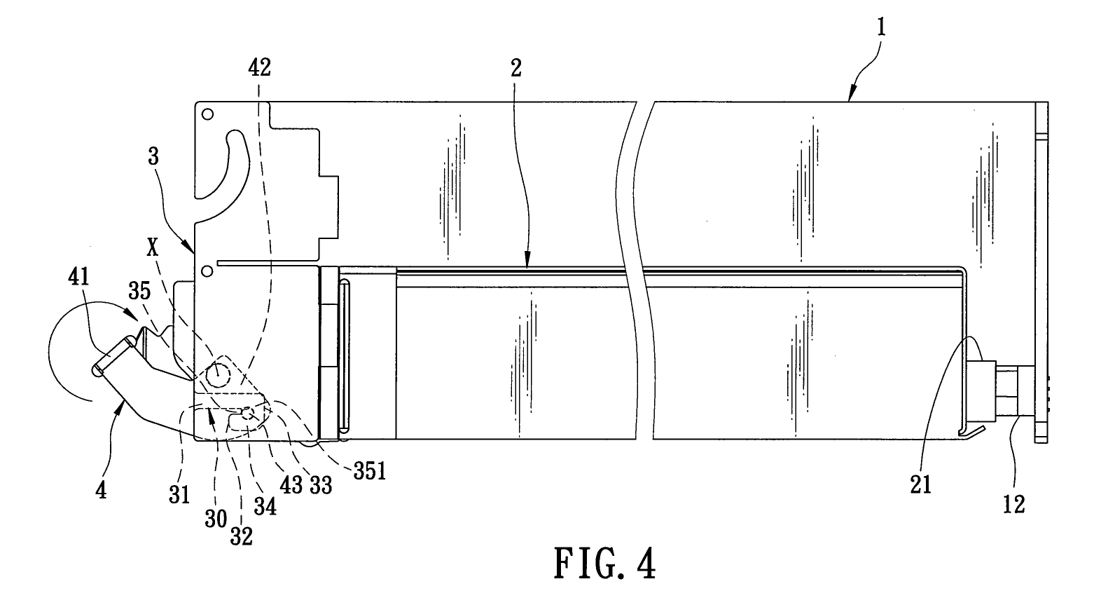

Referring further to FIGS. 4 to 7, during assembly of the detachable module 2 to the housing 1, after insertion of the detachable module 2 into the selected insertion groove 11 in the housing 1 via the front open side 10, initially, the positioning rods 43 of the pivot blocks 42 of the pivot member 4 are guided respectively by the first slot portions 31 of the guiding slots 30 in the guiding members 3 to move rearwardly toward the corresponding connecting port 12 as a result of continuous rearward movement of the detachable module 2 until the positioning rods 43 of the pivot blocks 42 of the pivot member 4 abut respectively against the rear stop walls 33 of the guiding member 3, as shown in FIG. 3. At the same time, the connector 21 of the detachable module 2 contacts merely but is not connected electrically to the selected connecting port 12.

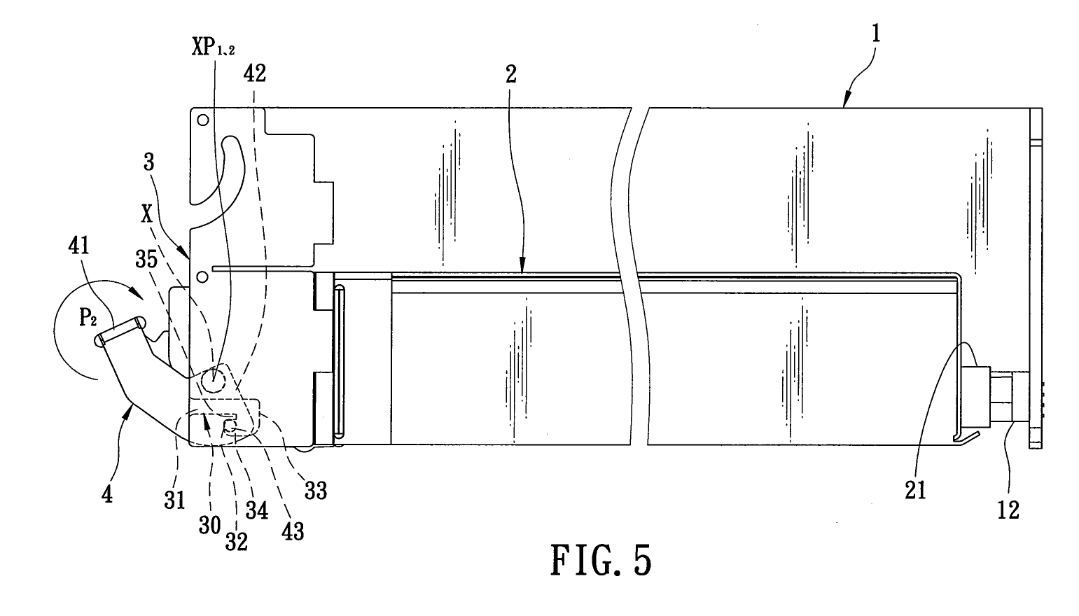

Subsequently, the pivot member 4 is pivoted about the axis (X) in a clockwise direction from an initial first position (P₁) to an intermediate second position (P₂) so as to pivot the pivot blocks 42 such that the positioning rods 43 of the pivot blocks 42 of the pivot member 4 move downwardly and frontwardly until the positioning rods 43 of the pivot blocks 42 of the pivot member 4 abut respectively against the front stop walls 32 of the guiding members 3, as shown in FIG. 5. At this time, due to the presence of the protrusion 35 of each pivot member 3, removal of each positioning rod 43 from the front stop wall 32 is prevented. Additionally, during pivoting of the pivot member 4 from the first position (P₁) to the second position (P₂), although the positioning rods 43 contact respectively rear end surfaces 351 of the protrusions 35 of the guiding members 3, as shown in FIG. 4, subsequent movement of the positioning rods 43 is not affected.

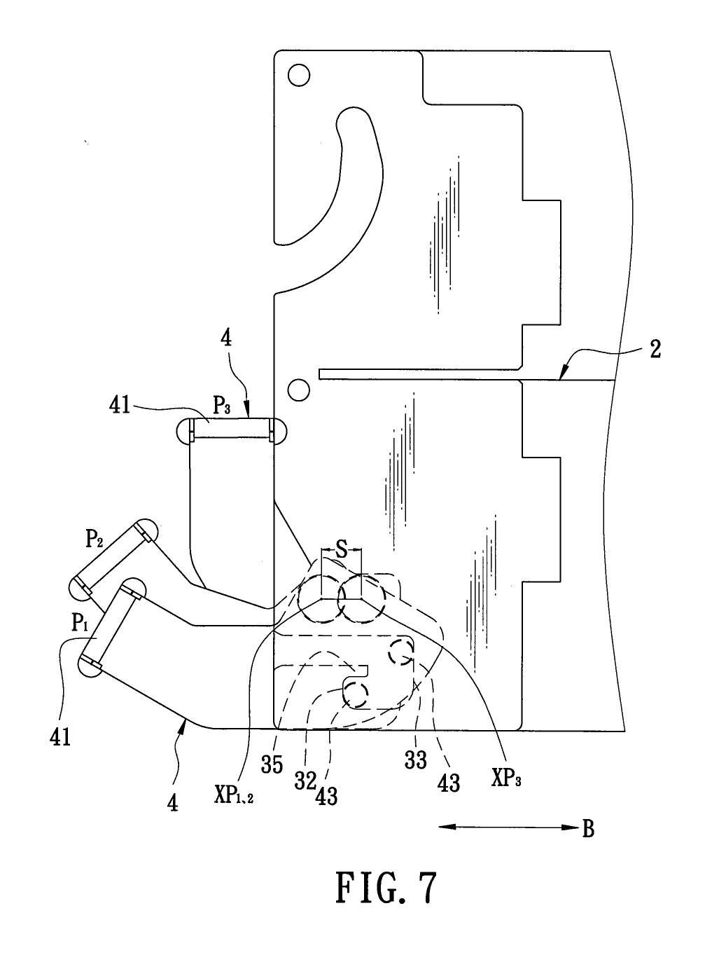

Thereafter, the pivot member 4 is continuously pivoted about the axis (X) in the clockwise direction from the second position (P₂) to a final third position (P₃). Further rearward movement of the detachable module 2 results from the continuous pivoting of the pivot member 4 from the second position (P₂) to the third position (P₃) since the positioning rods 43 abut respectively against the front stop walls 32 of the guiding members 3. In other words, a distance of the further rearward movement of the detachable module 2 is substantially equal to a movement distance (S) of the axis (X) from a position (XP_{1,2}), where the pivot member 4 is in one of the first and second positions (P₁, P₂), to a position (XP₃), where the pivot member 4 is in the third position (P₃), as shown in FIG. 7. At this time, due to the further rearward movement of the detachable module 2, the connector 21 of the detachable module 2 is connected electrically to the selected connecting port 12.

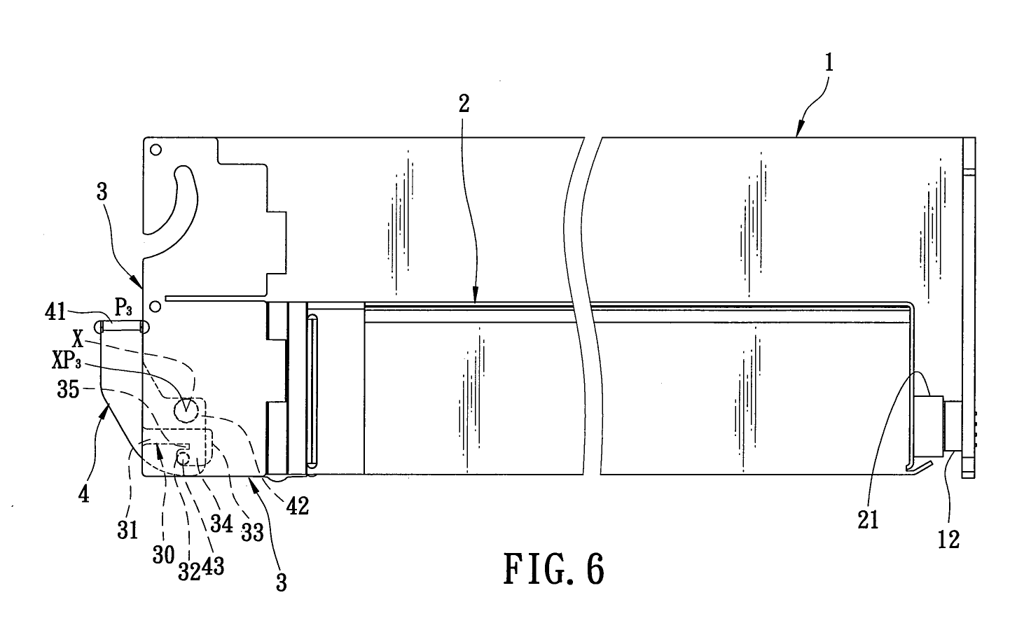

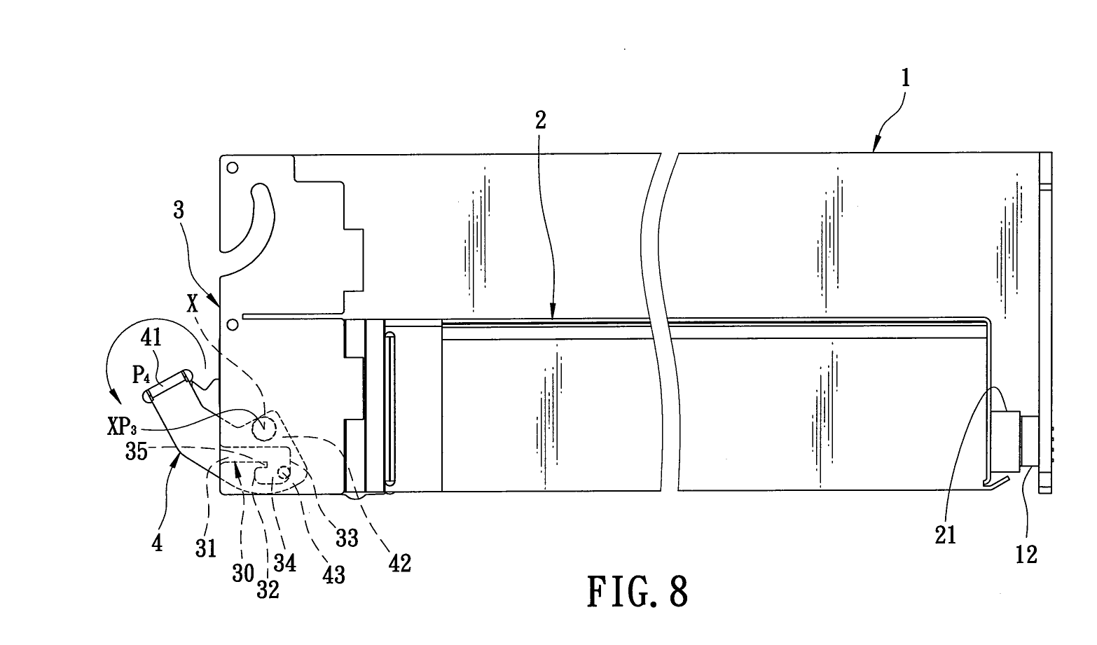

Referring further to FIGS. 6, 8 and 9, during disassembly of the detachable module 2 from the housing 1, initially, the pivot member 4 is pivoted about the axis (X), which is at the position (XP₃), in a counterclockwise direction from the third position (P₃) to an intermediate fourth position (P₄) so as to pivot the pivot blocks 42 such that positioning rod 43 of each pivot block 42 of the pivot member 4 moves upwardly and rearwardly in the second slot portion 34 of the guiding slot 30 in the corresponding guiding member 3 until the positioning rods 43 of the pivot blocks 42 of the pivot member 4 abut respectively against the rear stop walls 32 of the guiding members 3, as shown in FIG. 8.

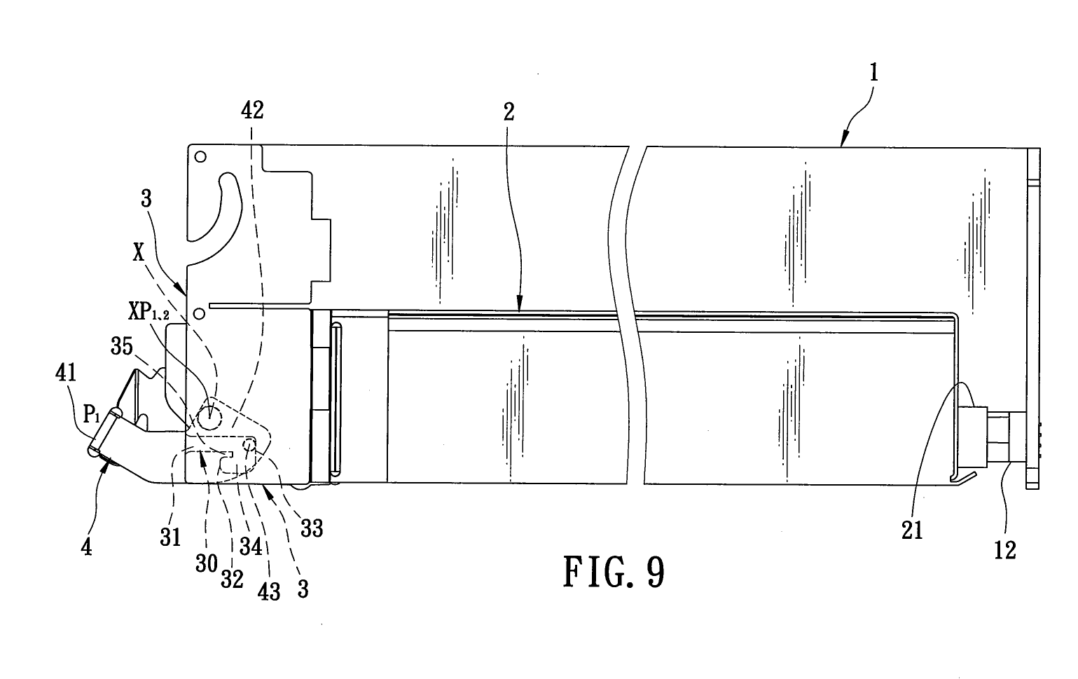

Subsequently, the pivot member 4 is continuously pivoted about the axis (X) in the counterclockwise direction from the fourth position (P₄) to the first position (P₁). Hence, since the positioning rods 43 are blocked respectively by the rear stop walls 33 of the guiding members 3, the positioning rods 43 move upwardly and respectively along the rear stop walls 22 of the guiding members 3 such that the axis (X) is moved from the position (XP₃) to the position (XP_{1,2}), thereby resulting in frontward movement of the detachable module 2 that causes the connector 21 of the detachable module 2 to be disconnected from the selected connecting port 12, as shown in FIG. 9.

Thereafter, the detachable module 2 can be moved away from the housing 1 by operating the pivot member 4 to move frontwardly and respectively the positioning rods 43 along the first slot portions 31 of the guiding slots 30 in the guiding members 3.

In such a configuration, the positioning device of the present invention enables the detachable module 2 to be easily positioned in and detached from the housing 1 without the need for tools, thereby resulting in convenience during assembly and disassembly. Furthermore, the distance (S) derived from the pivot member 4 can be designed to be suitable for various housings with different specifications, thereby resulting in superior applicability.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A positioning device adapted for positioning a detachable module in a housing, the housing having a front open side, said positioning device comprising:
a pair of guiding members adapted to be mounted fixedly in the housing and spaced apart from each other in a first direction, each of said guiding members being formed with a hook-shaped guiding slot, said guiding slot in each of said guiding members having an elongate first slot portion that extends rearwardly from a front end of a corresponding one of said guiding members, and a curved second slot portion connected to said first slot portion and extending downwardly and frontwardly from a rear end of said first slot portion, each of said guiding members having front and rear stop walls spaced apart from each other in a second direction that is perpendicular to the first direction and defining said second slot portion of said guiding slot in the corresponding one of said guiding members therebetween; and
a pivot member adapted to be mounted pivotally on the detachable module such that said pivot member is pivotable relative to the detachable module about an axis parallel to the first direction, said pivot member having opposite pivot blocks adapted to be connected respectively and pivotally to opposite lateral sides of the detachable module, each of said pivot blocks being disposed between a corresponding one of said guiding members and the detachable module when the detachable module is inserted into the housing via the front open side, each of said pivot blocks having an integral positioning rod that extends outwardly in the first direction;
whereby, during assembly of the detachable module to the housing, initially, said positioning rods of said pivot blocks of said pivot member are guided respectively by said first slot portions of said guiding slots in said guiding members to move rearwardly as a result of rearward movement of the detachable module until said positioning rods of said pivot blocks of said pivot member abut respectively against said rear stop walls of said guiding members, and subsequently, said pivot member is operable so as to pivot said pivot blocks of said pivot member such that said positioning rods of said pivot blocks of said pivot member move downwardly and frontwardly to abut respectively against said front stop walls of said guiding members, thereby resulting in further rearward movement of the detachable module in response to continuous pivoting of said pivot member by a predetermined distance.

2. The positioning device as claimed in claim 1, wherein said pivot member further has an intermediate handgrip interconnecting fixedly said pivot blocks.

3. The positioning device as claimed in claim 1, wherein each of said guiding members further has a protrusion that extends rearwardly from an upper end of said front stop wall.
